(19) United States
(12) Patent Application Publication
(10) Pub. No.: US 2026/0189497 A1
(43) Pub. Date: Jul. 2, 2026

(54) METHOD AND DEVICE FOR TRANSMITTING ITEMS OF DATA TO AN ACCESS NETWORK

(71) Applicant: Orange, Issy-les-Moulineaux (FR)

(72) Inventors: Xavier Le Guillou, Chatillon (FR); Fabrice Fontaine, Chatillon (FR)

(21) Appl. No.: 18/863,835

(22) PCT Filed: Apr. 26, 2023
(86) PCT No.: PCT/EP2023/061045

§ 371 Date: Nov. 7, 2024

(30) Foreign Application Priority Data
May 10, 2022 (FR) FR2204417

(51) Int. Cl. H04L 45/28; H04L 12/28; H04L 43/0811

(52) U.S. Cl. CPC H04L 45/28; H04L 12/2856; H04L 43/0811

(57) ABSTRACT

A method for transmitting items of data is disclosed, the method including detecting, by a first home gateway managed by a telecommunications operator, a loss or degradation of a connection between the first home gateway and an access network; searching for a second home gateway broadcasting a wireless local area network reachable by the first home gateway; checking whether the second home gateway is managed by the telecommunications operator or by a partner telecommunications operator by comparing at least one portion of a network identifier of the second home gateway with the identifiers on a predetermined list of network identifiers; and routing, to the second home gateway, items of data sent by the first home gateway or by an electronic device connected to the local area network administered by the first home gateway, the items of data being intended for transmission to a final recipient accessible through the access network. The method also includes transmitting, by the second home gateway and to the final recipient, the items of data through the access network.

### TECHNICAL FIELD

The present invention belongs to the general field of telecommunications. It more particularly relates to a data transmission method which offers continuity of service in the event of a failure or degradation of the quality of a connection between a home gateway and an access network such as the Internet. It also relates to a home gateway configured to transmit data to an access network, as well as a system for transmitting data to an access network.

### PRIOR ART

The advent of commercial offers called “triple play” offers that aim to provide a customer with an Internet access service, a “voice over IP”-type telephone service and an on-demand television and/or video service have promoted the installation of home gateways at the customer premises (i.e., individuals and/or companies) subscribing to these commercial offers.

These home gateways are network termination equipment and are often called “box”, CPE (Customer Premises Equipment), or HG (Home Gateway). The main role of a home gateway is to establish and manage the connection between a Local Area Network and an access network (also commonly called Wide Area Network), such as the Internet.

Typically, a home gateway integrates a router, a wireless network access point, a switch and a modem. This home gateway is generally configured to perform a Network Address Translation by allowing electronic devices on the local area network that have private addresses, which are neither unique nor routable at an access network level, to communicate with the rest of said access network by using external public, unique and routable addresses.

In the event of a failure of this home gateway, there are service restoration systems but they are not always sufficient and may require the intervention of a technician, particularly when the failure concerns the connection between said gateway and the access network. Moreover, these service restoration systems do not include technical means intended to guarantee continuity of service autonomously. Internet access, telephone and/or television services are then unavailable until the failure is resolved by the telecommunications operator.

### DISCLOSURE OF THE INVENTION

The present invention aims to overcome all or part of the drawbacks of the prior art, in particular those set out above, by proposing a solution that makes it possible to guarantee continuity of service when the quality of a connection between a home gateway and an access network is degraded, by making use autonomously of a home gateway located in the neighborhood and managed by the same telecommunications operator or by a telecommunications operator with which a partnership has been concluded. Thanks to these provisions, the home gateway can continue to provide the services to which the customer has subscribed. It is recalled that the current service restoration systems do not include technical means intended to guarantee continuity of service autonomously.

The fact that a home gateway makes use of other home gateways autonomously improves substantially the customer experience and satisfaction, since no customer intervention is necessary to restore the connection, and a fortiori the accessibility to the subscribed services.

For this purpose, and according to a first aspect, the invention relates to a data transmission method comprising:
detecting, by a first home gateway managed by a telecommunications operator, a loss of connection between said first home gateway and an access network, or the degradation of the connection between said first home gateway and said access network;
searching, by said first home gateway, for a second home gateway broadcasting a wireless local area network reachable by said first home gateway;
verifying, by said first home gateway, that said second home gateway is managed by said telecommunications operator or by a partner telecommunications operator by comparing at least part of a network identifier of the second home gateway with the identifiers of a predetermined list of network identifiers;
routing, by said first home gateway and to said second home gateway, data emitted by the first gateway or by an electronic device connected to a local area network administered by the first home gateway, said data being intended to be transmitted to a final recipient accessible via said access network; and,
transmitting, by said second home gateway and towards the final recipient, said data via the access network.

In general, it is considered that the steps of a method should not be interpreted as being linked to a notion of temporal succession.

In particular modes of implementation, the training method can further include one or more of the following characteristics, taken separately or in all technically possible combinations.

In particular modes of implementation, the research comprises:
searching, by said first home gateway, for at least one local area network broadcast by a second candidate home gateway, said local area network being reachable by said first home gateway;
identifying, by said first home gateway, a plurality of local area networks reachable by the first home gateway and broadcast by second candidate home gateways;
obtaining, by said first home gateway and for each local area network of the plurality, information relating to the quality of the connection between the second candidate home gateway and said access network and/or between said first home gateway and said second candidate home gateway; and,
selecting said second home gateway from among the plurality of second candidate home gateways, as a function of the information relating to the quality of connection.

In particular modes of implementation, the method further comprises a step of authenticating the second home gateway by the first home gateway, said authentication step comprising:
obtaining a certificate from said second home gateway;
applying a hash function to the certificate data, so as to obtain hashed data;
obtaining a public key from a certification authority that generated said certificate;
decrypting the signature of said authority with said public key; and,
comparing the result of said decryption with said hashed data.

In particular modes of implementation, the method further comprises a step of authenticating the second home gateway, by said first home gateway, by using a cryptographic key.

In particular modes of implementation, the method further comprises pairing the first gateway with the second gateway.

In particular modes of implementation, the method further comprises a step of generating, by said first home gateway, a secure communication tunnel between said first home gateway and said second home gateway.

In particular modes of implementation, the method further comprises:
receiving, by the second home gateway, data intended for an electronic device connected to the local area network administered by said first home gateway; and,
routing, by the second home gateway and to the first home gateway, said data intended for an electronic device.

According to a second aspect, the invention relates to a home gateway called first home gateway, comprising:
a module for detecting a loss of connection between said first home gateway and an access network, or the degradation of the connection between said first home gateway and said access network;
a module for searching for a second home gateway broadcasting a wireless local area network reachable by said first home gateway;
a module for verifying that said second home gateway is managed by said telecommunications operator or by a partner telecommunications operator, said module being configured to compare at least part of a network identifier of the second home gateway with the identifiers of a predetermined list of network identifiers; and,
a module for routing, to said second home gateway, data emitted by the first home gateway or by an electronic device connected to a local area network administered by the first home gateway, said data being intended to be transmitted to a final recipient accessible via said access network.

According to a third aspect, the invention relates to a system for transmitting data to an access network comprising a first home gateway according to the invention and a second home gateway, said first and second home gateways being managed by the same telecommunications operator, said second home gateway being connected to said access network and comprising:
a module for receiving data coming from the first home gateway and towards a final recipient; and,
a module for transmitting data towards said final recipient via said access network.

According to a fourth aspect, the invention relates to a computer program including instructions for the implementation of a transmission method according to the invention, when said program is executed by a processor.

According to a fifth aspect, the invention relates to a computer-readable recording medium on which the computer program according to the invention is recorded.

### BRIEF DESCRIPTION OF THE DRAWINGS

Other characteristics and advantages of the present invention will emerge from the description given below, with reference to the appended drawings which illustrate one exemplary embodiment thereof without any limitation. In the figures:

FIG. 1 schematically represents a data transmission system comprising a first and a second home gateway according to one exemplary embodiment of the invention;

FIG. 2 schematically represents one exemplary embodiment, in accordance with the invention, of a data transmission system comprising a first and a second home gateway;

FIG. 3A schematically represents one exemplary hardware architecture of a first home gateway according to the invention belonging to the data transmission system of [FIG. 1];

FIG. 3B schematically represents one exemplary hardware architecture of a second home gateway according to the invention belonging to the data transmission system of [FIG. 1];

FIG. 4 represents, in flowchart form, a data transmission method, as implemented by the first and second home gateways of FIGS. 3A and 3B.

### DESCRIPTION OF THE EMBODIMENTS

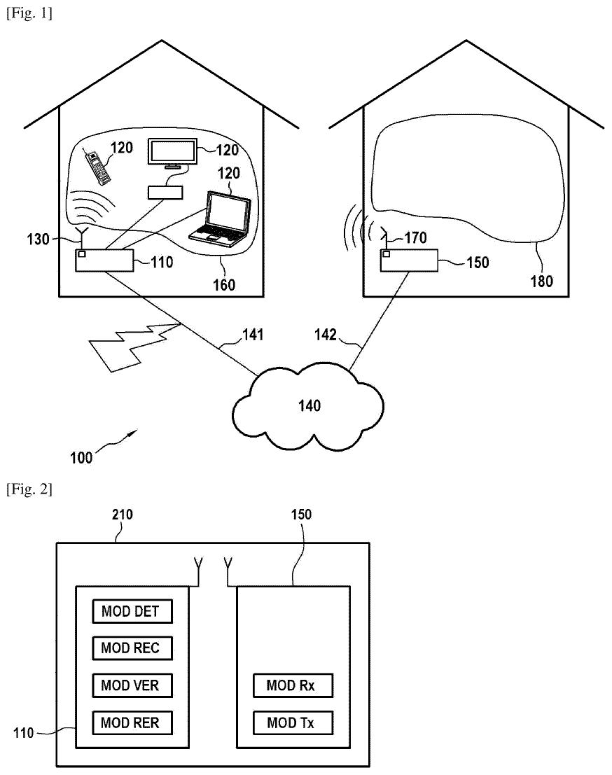

FIG. 1 schematically represents a data transmission system comprising a first and a second home gateway according to one exemplary embodiment of the invention.

The data transmission system 100 comprises a first home gateway 110 equipped with an access point 130. The first gateway administers a local area network 160, for example within a first home, which comprises a set of electronic devices 120 connected to the first home gateway 110 via a wired or non-wired connection. These electronic devices 120 can for example comprise a computer, a telephone, home automation equipment and/or a television.

The system 100 also comprises a second home gateway 150 equipped with an access point 170 so as to generate a local area network 180. This second gateway is for example positioned within a second home located in the vicinity of the first home.

The first and second gateways are both connected to an access network 140.

In response to the detection of a loss of connection 141 between the first home gateway and the access network or of the degradation of the connection 141 between the first home gateway and the access network, said first gateway searches for a second home gateway managed by the same operator or by another operator with which a partnership has been concluded and broadcasting a wireless local area network reachable by said first home gateway. Then, this first home gateway serves as a relay by routing, to said second gateway, data coming from the electronic devices 120 and towards the access network 140.

In response to the receipt of these data, the second gateway 150 transmits these data to the wide area network 140 via the connection 142 connecting the second gateway 150 to said access network 140.

FIG. 2 schematically represents one exemplary embodiment, in accordance with the invention, of a data transmission system comprising a first and a second home gateway.

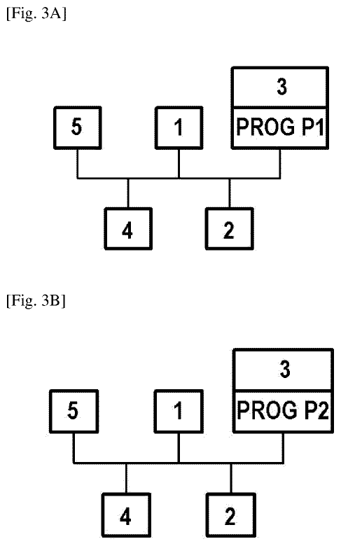

FIG. 3A schematically represents one example of hardware architecture of a first home gateway according to the invention belonging to the data transmission system of [FIG. 1].

As illustrated in [FIG. 3A], the first gateway has the hardware architecture of a computer. Thus, the system includes, in particular, a processor 1, a random access memory 2, a read-only memory 3 and a non-volatile memory 4. It further includes a communication module 5.

The read-only memory 3 of the system constitutes a recording medium as proposed, readable by the processor 1 and on which a computer program PROG_P1 in accordance with the invention is recorded, including instructions for the execution of steps of the transmission method as proposed. The program PROG_P1 defines functional modules of the first gateway 110 as represented in [FIG. 2], which rely on or control the hardware elements 1 to 5 of the gateway cited above, and which comprise in particular:
a module MOD_DET for detecting a loss of connection between the first home gateway and the access network or the degradation of the connection between the first home gateway and the access network;
a module MOD_REC for searching for a second home gateway broadcasting a wireless local area network reachable by said first home gateway;
a module MOD_VER for verifying that said second home gateway is managed by the same telecommunications operator as the one managing said first gateway or by a partner telecommunications operator, said module being configured to compare an SSID (Service Set Identifier) network identifier of the second home gateway with the identifiers of a predetermined list of network identifiers; and,
a module MOD_RER for routing, to said second home gateway, data emitted by the first gateway or by an electronic device connected to a local area network administered by said first home gateway, said data being intended to be transmitted to a final recipient accessible via said access network.

Moreover, the first gateway can further include other modules, in particular to implement particular modes of the transmission method, as described in more detail later.

It should be noted that the module MOD_DET for detecting a loss of connection or the degradation of a connection is configured to verify whether the services subscribed by the customer are accessible, and this with a nominal quality of service. The reference frame used to characterize a nominal level of provision of a service can be calculated locally by the first gateway based on heuristics or provided by the telecommunications operator as input information of a dedicated application of the first gateway. This information is specific to each service and to the underlying technologies used for the provision of a service.

This module MOD_DET is also responsible for the detection of any loss of connectivity in the access network, and makes it possible to distinguish whether a failure comes from the local area network or the access network. Particularly, the status of the connection between the first gateway and the access network is monitored and regularly checked. For this, this module performs local tests, for example, on a regular basis or when some predetermined events occur. The results of these tests are recorded locally in order to assess any deviation in the behavior of the first gateway. These results are also time-stamped in order to facilitate the correlation between the detected failure and configuration operations performed by the customer.

The rate of erroneous or lost packets, the percentage of retransmitted packets, the latency, the disconnection duration per day, the modification of the noise margin and the DLM (Dynamic Line Management) profile applied constitute non-limiting examples of indicators that can be combined with each other in order to determine a stability measurement (for example daily and/or weekly) of the connection, and therefore a fortiori detect a degradation of a connection.

The module MOD_REC for searching for a second home gateway broadcasting a wireless local area network reachable by said first home gateway is configured to discover the presence of access points in its vicinity. This module can also obtain information relating to the configurations of these access points, such as the SSID network identifier of the local area network(s) they support.

Particularly, when the wireless local area network is a Wi-Fi network compliant with the IEEE 802.11 standard and when the search is called “active” search, the module MOD_REC is configured to broadcast frames indicating that an access point is being sought. According to one particular implementation, these frames comprise an indication that the search follows a loss of connection or a degradation of the connection between the first home gateway and the access network. According to one particular implementation, the frames also comprise all or part of the data relating to the quality of the connection recovered by the module MOD_DET.

In response, the access point(s) having received the broadcast frames transmit their SSID and other information relating to their configuration. According to one particular implementation, the access point(s) transmit an indication that they give or don't give their agreement for the first gateway to connect to it or to them. This agreement (or disagreement) is for example determined as a function of the quality of the connection between the second gateway and the access network and/or as a function of a configuration of the second gateway by the user, the administrator or the operator managing this second gateway. According to one particular implementation, the access point(s) also transmit an indication relating to the quality of the connection between the second gateway and the access network towards the first gateway, so as to allow the first gateway to select the access point having an optimal or even maximum connection.

The first gateway then selects one of the access points, for example as a function of the quality of the connection between the first gateway and the second gateway and/or of the quality of the connection between the second gateway and the access network.

Once the access point has been selected, the first gateway then transmits a request to pair with the gateway associated with this access point. If the pairing is validated, a confirmation message is transmitted to the first gateway which indicates that the pairing is operational.

The first gateway also comprises a module configured to implement an authentication process for the second gateway. This authentication process can use a cryptographic key which is for example a WEP, WPA, WPA2 key or the like. As a variant, to increase security compared to these key-based solutions, a protocol of the EAP (Extensible Authentication Protocol) type using an authentication server can be implemented. This security protocol uses an authentication certificate stored both in an authentication server and in a memory of the second home gateway.

At the end of this authentication process, if it is a first connection to the second gateway, the SSID network identifier of the second gateway and the possible security key are stored in the non-volatile memory 4 of the first gateway.

Moreover, it should be noted that advantageously, the channels used for the connections first gateway 110-local area network 160, first gateway 110-second gateway 150 and second gateway 150-local area network 180 are distinct channels, so that one is not disturbed by the other.

The communication module 5 in particular allows the first gateway to communicate with an access network 140, with the electronic devices 120 of the local area network 160, and with the access point 170 of the second gateway 150. To do so, the communication module 5 includes a first wired or non-wired communication interface able to implement any protocol supported by the access network 140, a second wireless communication interface for connecting the electronic devices of the local area network 160 to the first gateway and which can serve as a fallback interface, and possibly as a third wired communication interface also making it possible to connect the electronic devices of the local area network 160 to this first gateway.

FIG. 3B schematically represents one example of hardware architecture of a second home gateway according to the invention belonging to the data transmission system of [FIG. 1].

As illustrated by [FIG. 3B], the first gateway has the hardware architecture of a computer. Thus, the system includes, in particular, a processor 1, a random access memory 2, a read-only memory 3 and a non-volatile memory 4. It further includes a communication module 5.

The read-only memory 3 of the system constitutes a recording medium as proposed, readable by the processor 1 and on which a computer program PROG_P2 in accordance with the invention is recorded, including instructions for the execution of some of the steps of the transmission method as proposed. The program PROG_P2 defines functional modules of the second gateway 150 as represented in [FIG. 2], which rely on or control the hardware elements 1 to 5 of the gateway cited above, and which comprise in particular:
a module MOD_RX for receiving data coming from the first home gateway and towards a final recipient; and,
a module MOD_TX for transmitting data towards said final recipient via said access network.

The communication module 5 in particular allows this second gateway to communicate with an access network 140, with the electronic devices of a local area network 180, and with the access point 130 of the first gateway 110. To do so, the communication module 5 includes a first wired or non-wired communication interface able to implement any protocol supported by the access network 140, and a second wireless communication interface for connecting the electronic devices of the local area network 180 as well as the first gateway 110 to this second gateway 150.

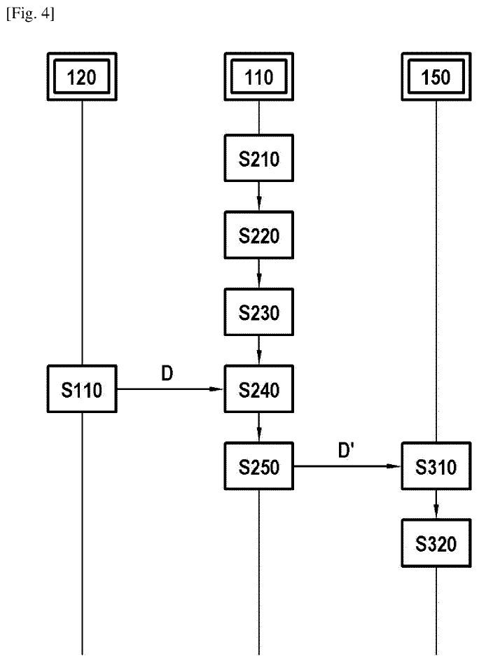

FIG. 4 represents, in the form of a flowchart, a data transmission method, as implemented by the first and second home gateways of FIGS. 3A and 3B.

During a first step S210, the first gateway 110 detects a loss of connection between itself and an access network 140 or detects the degradation of the connection between itself and this access network 140. This step is implemented by the module MOD_DET for detecting a loss of connection or the degradation of a connection.

In one embodiment, during this step S210, the first gateway 110 can also verify whether the services (e.g., telephone, television and/or Internet access services) subscribed by the customer are accessible, and this with a nominal quality of service. As indicated previously, the reference frame used to characterize a nominal level of provision of a service can be calculated locally by this first gateway based on heuristics or provided by the telecommunications operator as input information of a dedicated application of the first gateway. This information is specific to each service and to the underlying technologies used for the provision of a service.

According to the invention, during this step, it is also determined whether the failure comes from the local area network 160 or from the access network 140. Particularly, the status of the connection between the first gateway and the access network is monitored and regularly checked. For this, local tests are implemented, for example, regularly or when some predetermined events occur. The results of these tests are recorded locally in order to make it possible to evaluate any deviation in the behavior of the first gateway. The results are time-stamped in order to facilitate the correlation between the detected failure and configuration operations performed by the customer or requested by the operator.

The data transmission method comprises a second step S220 during which the first home gateway searches for a second home gateway broadcasting a wireless local area network reachable by said first home gateway.

In one embodiment, this search step S220 comprises:
a sub-step of searching for at least one local area network broadcast by a second candidate home gateway, said local area network being reachable by said first home gateway;
a sub-step of identifying a plurality of local area networks reachable by the first home gateway and broadcast by second candidate home gateways;
a sub-step of obtaining, for each local area network of the plurality, information relating to the quality of the connection between the second candidate home gateway and said access network and/or between said first home gateway and said second candidate home gateway; and,
a sub-step of selecting the second home gateway from among the plurality of second candidate home gateways, as a function of the information relating to the quality of connection.

More specifically, when the wireless local area network is a Wi-Fi network compliant with the IEEE 802.11 standard and when the search is called “active” search, the search sub-step comprises the broadcasting of frames indicating that an access point is being sought. In response, the access point(s) having received the broadcast frames transmit the SSID identifier of the local area network(s) they support, which is received by the first gateway during the identification sub-step.

In one embodiment, the selection sub-step aims to select the access point making it possible to obtain the best quality for the connection between the first gateway and the second gateway and/or for the connection between the second gateway and the access network 140. For this, different criteria can be considered, alone or in combination, such as the power of a received signal, a number of captured “Beacon” frames (and in this case the access points for which too few “Beacon” frames are received by the first gateway are excluded), the impact of surrounding channels on the channel of a given access point, an estimation of the bandwidth, or the number of electronic devices connected to an access point.

The transmission method also comprises a step S230 of verifying that the second home gateway is managed by the same telecommunications operator as the one managing the first gateway or by a telecommunications operator with which a partnership has been concluded. This verification step is for example implemented by comparing the SSID of the second home gateway with the SSIDs of a predetermined list of SSIDs stored in the memory of this first gateway.

In one embodiment, the transmission method also comprises a step of authenticating the second gateway which is implemented by the first gateway. This authentication process can use a cryptographic key which is, for example, a WEP, WPA, WPA2 key or the like.

As a variant, to increase security compared to these key-based solutions, a protocol of the EAP (Extensible Authentication Protocol) type using an authentication server can be implemented. This security protocol uses an authentication certificate stored both in an authentication server and in a memory of the second home gateway, and comprises:
a sub-step of obtaining, by the first gateway, a certificate of said second home gateway;
a sub-step of applying, by the first gateway, a hash function to the data of the certificate, so as to obtain hashed data;
a sub-step of obtaining, by the first gateway, a public key of a certification authority having generated said certificate;
a sub-step of decrypting, by the first gateway, the signature of said authority with said public key; and,
a sub-step of comparing, by the first gateway, the result of said decryption and said hashed data. If the result from this comparison step is that the result of the decryption and the hashed data are identical, then this means that the authentication is valid.

At the end of this authentication process, if it is a first connection to the second gateway, the SSID network identifier of the second gateway and the possible security key are stored in the non-volatile memory 4 of the first gateway.

Returning to [FIG. 4], the transmission method also comprises a step S110, implemented by an electronic device 120 for transmitting data packets intended for the access network 140.

In one embodiment, these packets are received by the first home gateway during a step S240, before being re-packaged (or re-encapsulated) to be transmitted during a step S250 towards the second home gateway. As a variant, the received packets are transmitted to the second gateway via a secure communication tunnel established between the first home gateway and the second home gateway.

Finally, the packets received by the second home gateway during a step S310 are then re-packaged before being transmitted via the access network 140 (step S320).

The invention has been described so far in the case where the data are emitted by a device of a local area network administered by the first gateway towards a recipient called “final recipient” accessible via an access network such as the Internet. The fact remains that the invention is also applicable in the case where a device not belonging to the local area network administered by said first gateway seeks to communicate with an electronic device of this local area network (120). In this case, the transmission method further comprises:
receiving, by the second home gateway, data intended for an electronic device (120) connected to the local area network (160) administered by said first home gateway; and,
routing, by the second home gateway and to the first home gateway, said data intended for an electronic device.

The invention has been described so far in the case where a SSID (Service Set Identifier) network identifier is used to identify a gateway. The invention nevertheless remains applicable in the case where only part of the SSID identifier is considered, or even in the case where the network identifier corresponds to an IP (Internet Protocol) address or to a MAC (Media Access Control) address.

1. A data transmission method comprising:
detecting, by a first home gateway managed by a telecommunications operator, a loss of a connection between said first home gateway and an access network, or a degradation of the connection between said first home gateway and said access network;
searching, by said first home gateway, for a second home gateway broadcasting a wireless local area network reachable by said first home gateway;
verifying, by said first home gateway, that said second home gateway is managed by said telecommunications operator or by a partner telecommunications operator by comparing at least part of a network identifier of the second home gateway with the identifiers of a predetermined list of network identifiers;
routing, by said first home gateway and to said second home gateway, data emitted by the first home gateway or by an electronic device connected to a local area network administered by the first home gateway, said data being intended to be transmitted to a final recipient accessible via said access network; and
transmitting, by said second home gateway and towards the final recipient, said data via the access network.

2. The data transmission method according to claim 1, wherein the searching for a second home gateway comprises:
searching, by said first home gateway, for at least one local area network broadcast by a second candidate home gateway, said local area network being reachable by said first home gateway;
identifying, by said first home gateway, a plurality of local area networks reachable by the first home gateway and broadcast by second candidate home gateways;
obtaining, by said first home gateway and for each local area network of the plurality, information relating to a quality of a connection between the second candidate home gateway and said access network and/or between said first home gateway and said second candidate home gateway; and
selecting said second home gateway from among the plurality of second candidate home gateways, as a function of the information relating to the quality of the connection.

3. The data transmission method according to claim 1 further comprising authenticating the second home gateway by the first home gateway, said authentication comprising:
obtaining a certificate from said second home gateway;
applying a hash function to the certificate data, so as to obtain hashed data;
obtaining a public key from a certification authority that generated said certificate;
decrypting the signature of said authority with said public key; and
comparing a result of said decryption with said hashed data.

4. The data transmission method according to claim 1 further comprising authenticating the second home gateway, by said first home gateway, by using a cryptographic key.

5. The data transmission method according to claim 1, further comprising pairing the first gateway with the second gateway.

6. The data transmission method according to claim 1, further comprising generating, by said first home gateway, a secure communication tunnel between said first home gateway and said second home gateway.

7. The data transmission method according to claim 1, further comprising:
receiving, by the second home gateway, data intended for an electronic device connected to the local area network administered by said first home gateway; and,
routing, by the second home gateway and to the first home gateway, said data intended for an electronic device.

8. A home gateway, comprising a processor, said home gateway configured to:
detect a loss of a connection between said home gateway and an access network, or a degradation of the connection between said home gateway and said access network;
search for a second home gateway broadcasting a wireless local area network reachable by said home gateway;
verify that said second home gateway is managed by said telecommunications operator or by a partner telecommunications operator, by comparing at least part of a network identifier of the second home gateway with identifiers of a predetermined list of network identifiers; and
route, to said second home gateway, data emitted by the home gateway or by an electronic device connected to a local area network administered by the home gateway, said data being intended to be transmitted to a final recipient accessible via said access network.

9. A system for transmitting data to an access network, the system comprising the home gateway of claim 8 and a second home gateway, said first and second home gateways being managed by the same telecommunications operator, said second home gateway being connected to said access network and comprising a processor, said second home gateway configured to:
receive data coming from the first home gateway and towards the final recipient; and
transmit data towards said final recipient via said access network.

10. A computer comprising a processor and a memory, said memory having stored thereon instructions which, when executed by the processor, cause the processor to implement the method of claim 1.

11. A non-transitory computer-readable recording medium having stored thereon instructions which, when executed by a processor, cause the processor to implement the method of claim 1.
